(19) United States
(12) Patent Application Publication
(10) Pub. No.: US 2025/0084998 A1
(43) Pub. Date: Mar. 13, 2025

(54) COOKTOP APPLIANCE AND METHOD OF DETECTING A SMART COOKWARE ITEM ON A COOKTOP APPLIANCE

(71) Applicant: Haier US Appliance Solutions, Inc., Wilmington, DE (US)

(72) Inventors: Samuel Joseph DuPlessis, Louisville, KY (US); Caleb Klenda, Louisville, KY (US)

(21) Appl. No.: 18/465,555

(22) Filed: Sep. 12, 2023

(51) Int. Cl. F24C 7/08; F24C 15/20; H05B 6/12

(52) U.S. Cl. CPC F24C 7/086; F24C 7/083; F24C 15/2021; H05B 6/1236

(57) ABSTRACT

A cooktop appliance includes a cooking surface, the cooking surface including a plurality of induction elements; a control panel operably coupled to the cooking surface, the control panel including a plurality of controls for operating the plurality of induction elements; and a controller operably coupled to the cooking surface and the control panel, the controller configured to perform an operation. The operation includes initiating a first induction element of the plurality of induction elements; receiving a remote signal from a first cookware item in response to initiating the first induction element; and pairing the first cookware item with the first induction element after receiving the remote signal from the first cookware item, wherein the first cookware item is subsequently activated for communication with the cooktop appliance.

### FIELD OF THE INVENTION

The present subject matter relates generally to cooking appliances, and more particularly to induction-based cooktop appliances and associated smart cookware items.

### BACKGROUND OF THE INVENTION

Traditional cooktop appliances include multiple heating elements (e.g., burners, electrical elements, induction elements) on which cookware items (e.g., pans, pots, etc.) may be placed to perform cooking operations. The heating elements may be energized to certain levels to reach desired temperatures for certain foods or items being cooked. In some instances, multiple heating elements may be used simultaneously to perform a plurality of cooking operations on a single cooktop. Recently, certain cookware items, such as smart cookware items have been introduced which communicate with the cooktop to perform feedback-based cooking operations.

In order to perform a proper feedback-based cooking operating, the smart cookware item should be matched with a particular heating element. For instance, the cookware item may include certain sensors to provide feedback to the appliance, which the appliance then analyzes to adjust the heating element accordingly. However, existing methods for pairing these cookware items have certain drawbacks. For example, extensive user interaction is required in order to pair a particular cookware item with a selected heating element. Moreover, if the cookware item is moved to a different burner, the feedback-based cooking operation may be terminated due to faults between the appliance and the cookware item.

Accordingly, a cooktop appliance which obviates one or more of the above-mentioned drawbacks would be beneficial. In particular, a cooktop appliance with detection features for cookware items would be useful.

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a cooktop appliance is provided. The cooktop appliance may include a cooking surface, the cooking surface including a plurality of induction elements, a control panel operably coupled to the cooking surface, the control panel including a plurality of controls for operating the plurality of induction elements, and a controller operably coupled to the cooking surface and the control panel, the controller configured to perform an operation. The operation may include initiating a first induction element of the plurality of induction elements, receiving a remote signal from a first cookware item in response to initiating the first induction element, and pairing the first cookware item with the first induction element after receiving the remote signal from the first cookware item, wherein the first cookware item is subsequently activated for communication with the cooktop appliance.

In another exemplary aspect of the present disclosure, a method of operating a cooktop appliance is provided. The cooktop appliance may include a plurality of induction elements. The method may include initiating a first induction element of the plurality of induction elements, receiving a remote signal from a first cookware item in response to initiating the first induction element, and pairing the first cookware item with the first induction element after receiving the remote signal from the first cookware item, wherein the first cookware item is subsequently activated for communication with the cooktop appliance.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooking appliance according to exemplary embodiments of the present disclosure.

FIG. 2 provides a top view of a cooktop appliance according to another exemplary embodiment of the present disclosure.

FIG. 3 provides a close-up view of a control input of the cooktop appliance of FIG. 2.

FIG. 4 provides a perspective view of a cookware item according to exemplary embodiments of the present disclosure.

FIG. 5 provides a schematic view of the cooktop appliance of FIG. 1 with an induction heating element of the cooktop appliance shown heating a cooking utensil on the induction heating element.

FIG. 6 provides a flow chart illustrating a method of operating a cooktop appliance according to exemplary embodiments of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

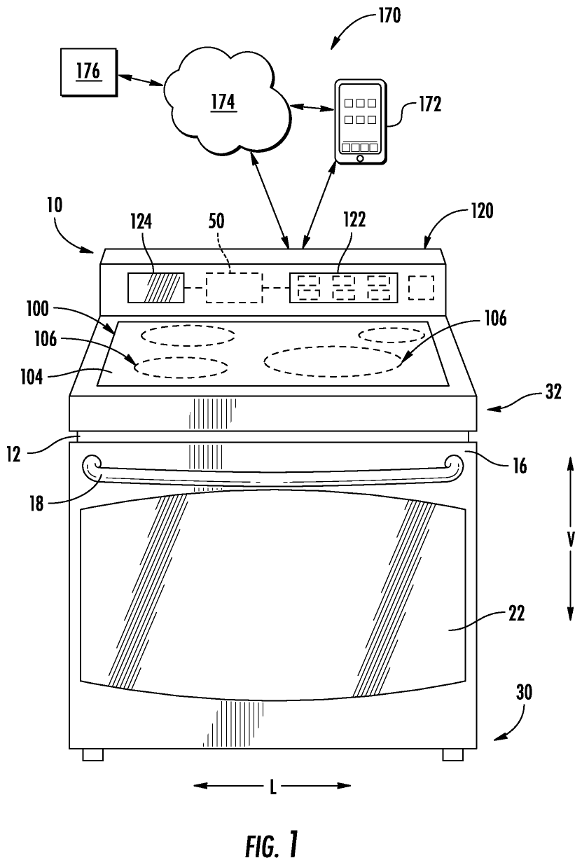

FIG. 1 provides a perspective view of an oven appliance (or cooking appliance) 10 according to an exemplary embodiment of the present disclosure. Oven appliance 10 is provided by way of example only and is not intended to limit the present subject matter in any aspect. Other oven or range appliances having different configurations, different appearances, or different features may also be utilized with the present subject matter as well (e.g., double ovens, electric cooktop ovens, stand-alone ovens, etc.).

Thus, the present subject matter may be used with other cooking appliance configurations (e.g., that define one or more cooktop surfaces including a plurality of heating elements or burners). Further, the present subject matter may be used in a stand-alone cooktop, range appliance, or any other suitable appliance.

Oven appliance 10 generally includes a cooking assembly. In particular, the cooking assembly may include one or more heating elements. For example, in some embodiments, the cooking assembly, and thus the oven appliance, 10 includes an insulated cabinet 12 with an interior cooking chamber defined by an interior surface of cabinet 12. The cooking chamber may be configured for the receipt of one or more food items to be cooked. The cooking chamber may be defined by a back wall, a top wall, and a bottom wall spaced from the top wall along the vertical direction V by opposing side walls (e.g., a first wall and a second wall).

Oven appliance 10 may include a door 16 rotatably mounted to cabinet 12 (e.g., with a hinge—not shown). A handle 18 may be mounted to door 16 and assists a user with opening and closing door 16 in order to access the cooking chamber. For example, a user can pull on handle 18 to open or close door 16 and access the cooking chamber.

Generally, oven appliance 10 may include a controller 50 in operative communication (e.g., operably coupled via a wired or wireless channel) with one or more other portions of oven appliance 10 (e.g., heating elements) via, for example, one or more signal lines or shared communication busses, and signals generated in controller 50 operate oven appliance 10 in response to user input via user inputs 122. Input/Output (“I/O”) signals may be routed between controller 50 and various operational components of oven appliance 10 such that operation of oven appliance 10 can be regulated by controller 50. In addition, controller 50 may also be in operative communication (e.g., wired or, alternatively, wireless communication) with one or more sensors, such as a first temperature sensor or a second temperature sensor. Generally, either or both the first temperature sensor and the second temperature sensor may include or be provided as a thermistor or thermocouple, which may be used to measure temperature at a location within or proximate to the cooking chamber, for example, and provide such measurements to the controller 50.

Controller 50 is a “processing device” or “controller 50” and may be embodied as described herein. Controller 50 may include a memory and one or more microprocessors, microcontrollers, application-specific integrated circuits (ASICS), CPUs or the like, such as general or special purpose microprocessors operable to execute programming instructions or micro-control code associated with operation of oven appliance 10, and controller 50 is not restricted necessarily to a single element. The memory may represent random access memory such as DRAM, or read only memory such as ROM, electrically erasable, programmable read only memory (EEPROM), or FLASH. In one embodiment, the processor executes programming instructions stored in memory. The memory may be a separate component from the processor or may be included onboard within the processor. Alternatively, controller 50 may be constructed without using a microprocessor (e.g., using a combination of discrete analog or digital logic circuitry; such as switches, amplifiers, integrators, comparators, flip-flops, AND gates, and the like) to perform control functionality instead of relying upon software.

Referring still to FIG. 1, a schematic diagram of an external communication system 170 will be described according to an exemplary embodiment of the present subject matter. In general, external communication system 170 is configured for permitting interaction, data transfer, and other communications between appliance 10 and one or more external devices. For example, this communication may be used to provide and receive operating parameters, user instructions or notifications, performance characteristics, user preferences, or any other suitable information for improved performance of appliance 10. In addition, it should be appreciated that external communication system 170 may be used to transfer data or other information to improve performance of one or more external devices or appliances and/or improve user interaction with such devices.

For example, external communication system 170 permits controller 50 of appliance 10 to communicate with a separate device external to appliance 10, referred to generally herein as an external device 172. As described in more detail below, these communications may be facilitated using a wired or wireless connection, such as via a network 174. In general, external device 172 may be any suitable device separate from appliance 10 that is configured to provide and/or receive communications, information, data, or commands from a user. In this regard, external device 172 may be, for example, a personal phone, a smartphone, a tablet, a laptop or personal computer, a wearable device, a smart home system, or another mobile or remote device. Additionally or alternatively, with respect to embodiments described herein, external device may be a cookware item (e.g., cookware item 160, described below).

In addition, a remote server 176 may be in communication with appliance 10 and/or external device 172 through network 174. In this regard, for example, remote server 176 may be a cloud-based server 176, and is thus located at a distant location, such as in a separate state, country, etc. According to an exemplary embodiment, external device 172 may communicate with a remote server 176 over network 174, such as the Internet, to transmit/receive data or information, provide user inputs, receive user notifications or instructions, interact with or control appliance 10, etc. In addition, external device 172 and remote server 176 may communicate with appliance 10 to communicate similar information.

In general, communication between appliance 10, external device 172, remote server 176, and/or other user devices or appliances may be carried using any type of wired or wireless connection and using any suitable type of communication network, non-limiting examples of which are provided below. For example, external device 172 may be in direct or indirect communication with appliance 10 through any suitable wired or wireless communication connections or interfaces, such as network 174. For example, network 174 may include one or more of a local area network (LAN), a wide area network (WAN), a personal area network (PAN), the Internet, a cellular network, any other suitable short- or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 170 is described herein according to an exemplary embodiment of the present subject matter. However, it should be appreciated that the exemplary functions and configurations of external communication system 170 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

Oven appliance 10 may include a cooktop 100. Cooktop 100 may be disposed on the cabinet 12 such that the total volume of cabinet 12 is generally divided between the cooking chamber and cooktop 100. As shown, cooktop 100 may include a top panel 104. By way of example, top panel 104 may be constructed of glass, ceramics, enameled steel, and combinations thereof. Heating assemblies 106 (e.g., induction heating elements, resistive heating elements, radiant heating elements, or gas burners) may be mounted, for example, on or below the top panel 104. While shown with four heating assemblies 106 in the exemplary embodiment of FIG. 1, cooktop appliance 10 may include any number of heating assemblies 106 in alternative exemplary embodiments. Heating assemblies 106 can also have various diameters. For example, each heating assembly of heating assemblies 106 can have a different diameter, the same diameter, or any suitable combination thereof. Moreover, one or more of the heating assemblies 106 may have varying diameters (e.g., multiple concentric rings offering different power levels and/or heat production).

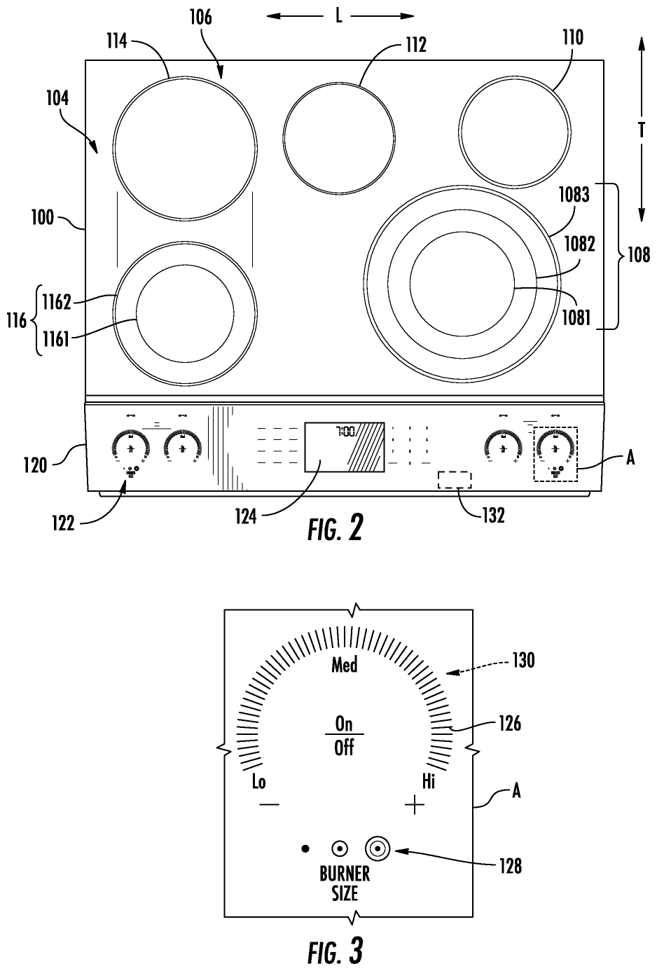

As shown, certain embodiments of oven appliance 10 include a user interface panel 120, which may be located as shown, within convenient reach of a user of the oven appliance 10. User interface panel 120 is generally a component that allows a user to interact with the oven appliance 10 to, for example, turn various heating elements (such as heating elements 106) on and off, adjust the temperature of the heating elements, set built-in timers, etc. Although user interface panel 120 is shown in FIG. 1 as being mounted to a backsplash fixed to cabinet 12, alternative embodiments may provide user interface panel 120 at another suitable location (e.g., on a front portion of cabinet 12 above door 16, as seen in FIG. 2).

In some embodiments, a user interface panel 120 may include one or more user-interface inputs 122 and a graphical display 124, which may be separate from or integrated with the user-interface inputs 122. The user-interface element 122 may include analog control elements (e.g., knobs, dials, or buttons) or digital control elements, such as a touchscreen comprising a plurality of elements thereon. Various commands for a user to select through the engagement with the user-interface inputs 122 may be displayed (e.g., by touchscreen at the inputs 122 or by the graphical display 124), and detection of the user selecting a specific command may be determined by the controller 50, which is in communication with the user-interface inputs 122, based on electrical signals therefrom. Additionally or alternatively, graphical display 124 may generally deliver certain information to the user, which may be based on user selections and interaction with the inputs 122, such as whether one or more heating elements within the cooking chamber are activated or the temperature at which the cooking chamber is set.

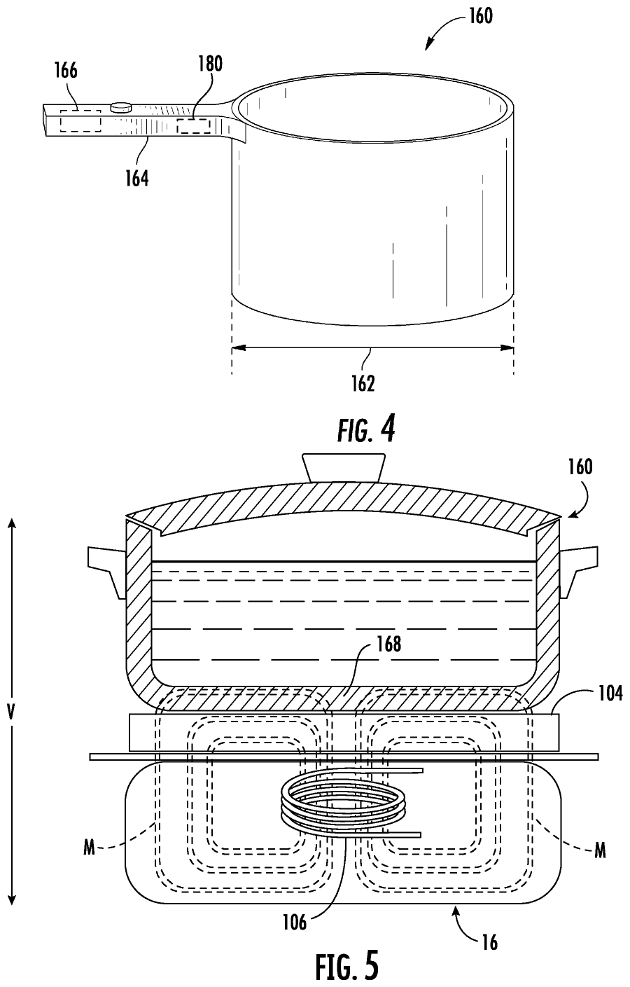

FIG. 2 provides a top view of an exemplary cooktop 100 and user interface panel 120 according to at least one embodiment of the present disclosure. As seen in FIG. 2, user interface panel 120 may be provided at or near a front of cooktop 100 (e.g., along a transverse direction T). Moreover, according to the embodiment shown in FIG. 2, cooktop 100 includes five burners (e.g., heating assemblies 106) spatially arranged thereon. As described above, cooktop 100 may include top panel 104 on which heating assemblies 106 are arranged. According to this example, the plurality of heating assemblies 106 are induction heating elements 106. Induction heating elements 106 will be described in detail below with reference to FIG. 5. Additionally or alternatively, at least some of the induction heating elements 106 may be variable in diameter.

Each of the plurality of heating elements 106 may be capable of providing selective levels of heat output (or power output for induction elements). In detail, a user may adjust a power level of a selected burner (or burner diameter) according to a desired heat level. Accordingly, a user may select first burner 108 at a first diameter (e.g., a first diameter 1081, a second diameter 1082, or a third diameter 1083). While first diameter 1081 outputs a first level of heat (e.g., at full power) that is less than an output of, for example, first diameter 1081 and a second diameter 1082 together, the user may adjust a total heat output of just the first diameter 1081 (e.g., via user interface panel 120, described below). Additionally or alternatively, a combination of heating elements 106 may be activated by the user. For example, the user can activate fourth element 114 and fifth element 116 (e.g., at a first diameter 1161 or a second diameter 1162) simultaneously to create a griddle burner. It should be understood that any suitable activation level or intensity of a selected burner (or burner diameter), as well as any suitable combination of burners or heating elements may be activated according to specific embodiments.

User interface panel (or control panel) 120 may include one or more user inputs 122. As discussed above, user inputs 122 may be analog or digital, or a combination thereof. For the embodiment described herein, user inputs 122 are touch inputs on user interface panel 120. Accordingly, user interface panel 120 may be referred to as a touch panel. User interface panel 120 may include a plurality of inputs 122, e.g., one for each burner (first burner 108, second burner 110, etc.). Inputs 122 may be spaced apart from each other along user interface panel 120. For instance, inputs 122 may be spaced apart along the lateral direction L. An exemplary input 122 is shown in subset A, which is provided in FIG. 3.

Input 122 may include a plurality of interactive controls. For instance, input 122 may include a power slider 126. As shown, power slider 126 may be provided as a semi-circular arc on touch panel 120. A user may adjust a power input to the respective burner by sliding a finger along the power slider 126. Additionally or alternatively, input 122 may include a burner size selector 128. As shown in FIG. 3, burner size selector 128 may include one or more indicators indicating a burner size (e.g., burner diameter). Using first burner 108 as an example, burner size selector 128 may include a first indicator with a single ring, a second indicator with two rings, and a third indicator with three rings. Burner size selector 128 may selectively illuminate or otherwise accentuate one or more of the plurality of indicators associated with the activated burner diameters. For at least one example, a user selects first burner 108 with first diameter 1081 and second diameter 1082 activated. Accordingly, burner size selector 128 illuminates or accentuates the second indicator to indicate that the first diameter 1081 and the second diameter 1082 are actively producing heat. Accordingly, a user may select which burner diameters will be active during a cooking operation.

User interface panel 120 may include one or more light sources 130. According to some embodiments, light sources 130 are provided behind (e.g., underneath) user inputs 122. For instance, each of power slider 126 and burner size selector 128 may have a dedicated light source which illuminates a selected portion of input 122 at a selected time. Additionally or alternatively, one or more light sources may be provided on an external surface of user interface panel 120. For instance, one or more light emitting diodes (LEDs) may be provided at or near user inputs 122 or display 124. Moreover, the one or more light emitting diodes may be activated independently from an operation or interaction with user inputs 122 or display 124.

Cooktop 100 may include a speaker 132. For instance, speaker 132 may be any suitable noise maker, such as a transducer, a buzzer, a bell, or the like. Speaker 132 may be selectively controlled by controller 50. Activation of speaker 132 may be combined with an activation of one or more of light sources 130.

Display 124 may be a digital display. For instance, display 124 may be a liquid crystal display (LCD) or any other suitable interactive display. Accordingly, display 124 may present one or more complex images associated with appliance 10 (e.g., cooktop 100). According to one embodiment, display 124 displays a plurality of rings associated with the plurality of burners 106 and burner diameters. Again referring to first burner 108 as an example, display 124 displays first burner 108 as three concentric circles representing first diameter 1081, second diameter 1082, and third diameter 1083. Display 124 may selectively illuminate or otherwise accentuate one or more of the plurality of rings associated with the activated burner diameters. For at least one example, a user selects first burner 108 with first diameter 1081 and second diameter 1082 activated. Accordingly, display 124 illuminates or accentuates a first ring and a second ring to indicate that the first diameter 1081 and the second diameter 1082 are actively producing heat.

FIG. 4 provides an exemplary cookware item 160. In detail, cookware item 160 may be a saucepan. Cookware item 160 may include a cylindrical body defining a bottom diameter 162 and a handle 164 extending from the body. Cookware item 160 shown in FIG. 4 is provided by way of example only, and it should be understood that any suitable piece of cookware (e.g., a pan, a pot, a griddle, a kettle, etc.) may be incorporated as a cookware item used herein. Cookware item 160 may include a wireless communication module 166 provided within handle 164. Wireless communication module 166 may selectively communicate with controller 50 of appliance 10. For instance, wireless communication module 166 may establish a wireless connection (e.g., via WiFi®, Bluetooth®, ZigBee®, or the like) with controller 50 to provide one or more signals indicating a status of cookware item 160 (e.g., awake, in use, current temperature, etc.). Moreover, wireless communication module 166 may include a memory that stores certain information regarding cookware item 160. Additionally or alternatively, controller 50 may store information regarding multiple cookware items 160, each cookware item 160 being identified via a cookware identifier.

Cookware item 160 may include a sensor 180. For instance, sensor 180 may be a temperature sensor. As used herein, “temperature sensor” or the equivalent is intended to refer to any suitable type of temperature measuring system or device positioned at any suitable location for measuring the desired temperature. Thus, for example, sensor 180 may be any suitable type of temperature sensor, such as a thermistor, a thermocouple, a resistance temperature detector, a semiconductor-based integrated circuit temperature sensors, etc. In addition, sensor 180 may be positioned at any suitable location and may output a signal, such as a voltage, to a controller (or to wireless communication module 166) that is proportional to and/or indicative of the temperature being measured. Although exemplary positioning of temperature sensors is described herein, it should be appreciated that cookware item 160 may include any other suitable number, type, and position of temperature, humidity, and/or other sensors according to alternative embodiments.

Sensor 180 may additionally or alternatively be sensitive to other stimuli. For instance, sensor 180 may receive, detect, or otherwise pick up certain noise from operations or influxes near to sensor 180. As mentioned above, heating element 106 may be induction elements. As will be described further below, induction element 106 may produce a magnetic field to be received by cookware item 106. According to at least some embodiments, sensor 180 may detect that cookware item 160 is being inducted upon, for instance, by induction element 106. When an induction process or operation is initiated at induction element 106, sensor 180 may detect high frequency noise (e.g., via a magnetic field). As will be described, appliance 10 may register and analyze the detected noise (e.g., high frequency noise).

FIG. 5 provides a schematic view of an induction heating element 106 shown heating a cooking utensil 18 supported on cooking surface 14 according to at least some embodiments. Induction heating element 106 may include a Lenz coil or wire 15. As will be understood by those skilled in the art, appliance 10 may supply a current to Lenz coil 15. As such, current may pass through Lenz coil 15 and Lenz coil 15 may generate a magnetic field (shown with dashed lines M). The magnetic field may be a high frequency circulating magnetic field. As shown in FIG. 5, Lenz coil 15 may be oriented such that magnetic field M is directed towards and through top panel (or cooking surface) 104 to cookware item 106. In particular, when magnetic field M penetrates cookware item 106, magnetic field M induces a circulating electrical current within cooking utensil 18, e.g., within a bottom wall 168 of cookware item 160. The material properties of cookware item 160 may restrict a flow of the induced electrical current and convert the induced electrical current into heat within cookware item 160. As cookware item 160 heats up, contents of cookware item 160 contained therein heat up as well. In such a manner, induction heating element 106 can cook the contents of cookware item 160.

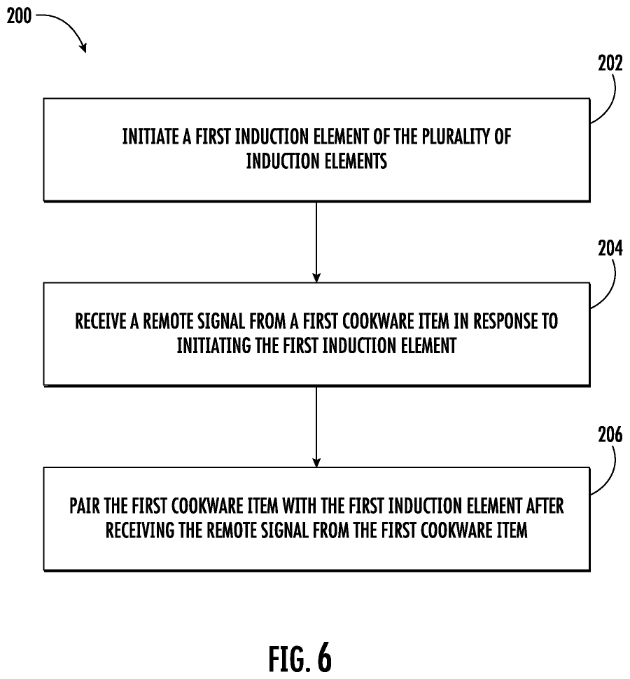

Now that the general descriptions of an exemplary appliance have been described in detail, a method 200 of operating an appliance (e.g., oven appliance 10 or cooktop 100) will be described in detail. Although the discussion below refers to the exemplary method 200 of operating oven appliance 10 or cooktop 100, one skilled in the art will appreciate that the exemplary method 200 is applicable to any suitable domestic appliance capable of performing a cooking operation (e.g., such as a stand-alone cooktop, an independent burner, etc.). In exemplary embodiments, the various method steps as disclosed herein may be performed by controller 50 and/or a separate, dedicated controller. FIG. 6 provides a flow chart illustrating a method of operating an exemplary cooktop, e.g., cooktop 100. Hereinafter, method 200 will be described with specific reference to FIG. 6.

At step 202, method 200 may include initiating a first induction element. The first induction element may be one of a plurality of induction elements (or burners) provided on a cooktop appliance (e.g., cooktop 100). For instance, a user may initiate a cooking operation utilizing the first induction element. According to some embodiments, the first induction element is initiated (or activated) via an interaction with a user interface (e.g., user interface panel 120). A user may touch, switch, turn, or otherwise manipulate a user interface item to produce an input signal to activate the first induction element. The appliance (e.g., via the controller) may then receive the input signal supplied through the control panel to energize the first induction element. When the first induction element is activated or initiated, a current (e.g., electrical current) is supplied to the first induction element (e.g., Lenz coil 15) to generate a magnetic field therefrom.

The initiation of the first induction element may include a pulsing of the first induction element. For instance, a predetermined duty cycle may be applied to the first induction element upon receiving the input signal. In detail, the first induction element may be activated at a first predetermined time interval. The first predetermined time interval may be immediately after receiving the input signal. Thus, the current may be supplied to the first induction element immediately upon receiving the input signal. The first induction element may thus be driven for a first predetermined amount of time (e.g., between about 1 second and about 5 seconds).

The first induction element may then be deactivated at a second time interval. For instance, the second time interval may be at an expiration of the first predetermined amount of time. By deactivating the first induction element, the current is no longer supplied thereto, and the magnetic field is therefore stopped. The first induction element may remain in the deactivated state for a second predetermined amount of time. According to at least some embodiments, the second predetermined amount of time is approximately equal to the first predetermined amount of time. Accordingly, the first induction element is pulsed after receiving the input signal. The activation and deactivation of the first induction element may be repeated a predetermined number of times (e.g., 2 times, 3, times, etc.).

At step 204, method 200 may include receiving a remote signal from a first cookware item in response to initiating the first induction element. In detail, the first cookware item may be configured to interact with the appliance (e.g., with the first induction element). The first cookware item may be activated (e.g., turned on) by a user. For instance, the user may activate a wireless communication module (e.g., wireless communication module 166) by pressing a button on the first cookware item. The first cookware item may then be activated to begin a sensing and/or communication process. As described above, the first cookware item (e.g., cookware item 160) may include one or more sensors (e.g., sensor 180). The sensor may be a temperature sensor, as described above. However, the sensor may be co-purposed. For instance, the sensor may be configured to detect, sense, determine, or otherwise obtain information aside from temperature. According to at least one embodiment, the sensor may determine that the first cookware item is being inducted upon.

As mentioned above, when the first induction element is activated (e.g., energized, initiated, driven, etc.), a magnetic field is generated, such as a high frequency circulating magnetic field. As the magnetic field passes through the first cookware item, a circulating electrical current may be induced through the cookware item. This electrical current may generate a high frequency noise component which may in turn be detected by the sensor. Similarly, when the first induction element is deactivated, the electrical current is subsequently stopped and the high frequency noise component is stopped. The sensor may determine that the first cookware is being inducted upon via detecting the high frequency noise components. The first cookware item may thus, via the wireless communication module, emit an induction confirmation signal to the appliance.

At step 206, method 200 may include pairing the first cookware item with the first induction element after receiving the remote signal from the first cookware item. In detail, the appliance may, after receiving the induction confirmation signal, establish a connection with the first cookware item. As mentioned previously, the wireless communication module within the first cookware item may be in an on or activated state when the first induction element is initiated. The appliance may receive the induction confirmation signal in response to the pulsation of the first induction element, thus confirming that the first cookware item is positioned on or over the first induction element.

In pairing the first cookware item with the first induction element, a closed loop cooking operation may be initiated and performed with respect to each of the first induction element and the first cookware item. For instance, the first cookware item may be associated with the first induction element for a duration of the closed loop cooking operation. Accordingly, the appliance may remain in wireless communication with the first cookware item for a duration of the closed loop cooking operation.

According to at least some embodiments, upon pairing the first cookware item with the first induction element, the first cookware item is also subsequently activated for communication with the appliance. For instance, the pairing of the first cookware item with the first induction element automatically places the first cookware item into a predetermined mode for performing the closed loop cooking operation. Advantageously, the first cookware item is initiated without additional user interaction with either the cookware item itself or the user interface of the appliance.

Method 200 may include emitting a notification that the first cookware item has been paired with the first induction element. For instance, upon a successful pairing of the first cookware item with the first induction element, the appliance may provide a notification or alert to the user of the pairing. The notification may be emitted or presented on the user interface panel (e.g., a display) of the appliance. Additionally or alternatively, the notification may be transmitted to a connected remote device of the user (e.g., such as a smartphone). Accordingly, the user may be properly notified as to the pairing and the subsequent initiation of the closed loop cooking operation.

Subsequent to pairing the first cookware item with the first induction element, method 200 may include initiating a second induction element of the plurality of induction elements. Similar to the first induction element, a user may initiate a cooking operation utilizing the second induction element. Thus, the second induction element may be initiated (or activated) via an interaction with a user interface. When the second induction element is activated or initiated, a current (e.g., electrical current) is supplied to the second induction element (e.g., Lenz coil 15) to generate a magnetic field therefrom.

The initiation of the second induction element may include a pulsing of the second induction element. Similar to the first induction element, a predetermined duty cycle may be applied to the second induction element upon receiving the input signal. In detail, the second induction element may be activated at a first predetermined time interval. The first predetermined time interval may be immediately after receiving the input signal. Thus, the current may be supplied to the second induction element immediately upon receiving the input signal. The second induction element may thus be driven for a first predetermined amount of time (e.g., between about 1 second and about 5 seconds).

The second induction element may then be deactivated at a second time interval. For instance, the second time interval may be at an expiration of the first predetermined amount of time. By deactivating the second induction element, the current is no longer supplied thereto, and the magnetic field is therefore stopped. The second induction element may remain in the deactivated state for a second predetermined amount of time. According to at least some embodiments, the second predetermined amount of time is approximately equal to the first predetermined amount of time. Accordingly, the second induction element is pulsed after receiving the input signal. The activation and deactivation of the second induction element may be repeated a predetermined number of times (e.g., 2 times, 3, times, etc.).

Method 200 may further include receiving a remote signal from a second cookware item in response to initiating the second induction element. Again similar to the first cookware item, the second cookware item may be configured to interact with the appliance (e.g., with the second induction element). The second cookware item may be activated (e.g., turned on) by a user. For instance, the user may activate a wireless communication module by pressing a button on the second cookware item. The second cookware item may then be activated to begin a sensing and/or communication process. As described above, the second cookware item may include one or more sensors. The sensor may be a temperature sensor, as described above. However, the sensor may be co-purposed. For instance, the sensor may be configured to detect, sense, determine, or otherwise obtain information aside from temperature. According to at least one embodiment, the sensor may determine that the second cookware item is being inducted upon and emit an induction confirmation signal to the appliance.

Method 200 may further include pairing the second cookware item with the second induction element. Again similar to the first cookware item, the appliance may, after receiving the induction confirmation signal, establish a connection with the second cookware item. As mentioned previously, the wireless communication module within the second cookware item may be in an on or activated state when the second induction element is initiated. The appliance may receive the induction confirmation signal in response to the pulsation of the second induction element, thus confirming that the second cookware item is positioned on or over the second induction element.

During the closed loop cooking operation(s), instances may occur in which the first cookware item is moved to the second (or a third, fourth, etc.) induction element. Thus, method 200 may include monitoring the closed loop cooking operation associated with the first induction element as well as monitoring the closed loop cooking operation associated with the second induction element. For instance, during the closed loop cooking operation(s), the first and second induction elements may be operated according to a duty cycle. As the paired cookware items routinely report temperature information to the appliance, the corresponding induction element may be cycled between an on state and an off state to maintain a desired temperature within the paired cookware item.

Each time the induction element (e.g., first induction element, second induction element) is activated, the appliance may receive an updated confirmation signal from the cookware item which is being inducted upon. For instance, the high frequency noise component is registered by the sensor of the cookware item being inducted upon each time the magnetic field is generated by the corresponding induction element. While the first cookware item is paired with the first induction element, the appliance may expect to receive the confirmation signal from the first cookware item each time the first induction element is activated.

In some instances, the first induction element is activated and the confirmation signal is returned by the second cookware item. Accordingly, the appliance may enter a predetermined mode (e.g., a test mode) to confirm which cookware item is in contact with which induction element. For instance, each of the first induction element and the second induction element (and any additional induction elements currently in operation) may be deactivated (e.g., may stop emitting the magnetic field). Additionally or alternatively, the first cookware item is unpaired from the first induction element and the second cookware item is unpaired from the second induction element.

The first induction element may then perform the pulsing operation (e.g., such as described with respect to step 202). The appliance may then receive the confirmation signal from the second cookware item. Subsequently, the second induction element may perform the pulsing operation. The appliance may then receive the confirmation signal from the first cookware item. The method may then include automatically swapping the paired cookware items with the respective induction elements. Accordingly, the closed loop cooking operations may continue with the new pairings (e.g., the first cookware item with the second induction elements and the second cookware item with the first induction element). Advantageously, a failure report may be avoided and the closed loop cooking operations may continue uninhibited.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A cooktop appliance, comprising:
a cooking surface, the cooking surface comprising a plurality of induction elements;
a control panel operably coupled to the cooking surface, the control panel comprising a plurality of controls for operating the plurality of induction elements; and
a controller operably coupled to the cooking surface and the control panel, the controller configured to perform an operation, the operation comprising:
initiating a first induction element of the plurality of induction elements;
receiving a remote signal from a first cookware item in response to initiating the first induction element; and
pairing the first cookware item with the first induction element after receiving the remote signal from the first cookware item, wherein the first cookware item is subsequently activated for communication with the cooktop appliance.

2. The cooktop appliance of claim 1, wherein the operation further comprises:
initiating a second induction element of the plurality of induction elements;
receiving a remote signal from a second cookware item in response to initiating the second induction element; and
pairing the second cookware item with the second induction element after receiving the remote signal from the second cookware item, wherein the second cookware item is subsequently activated for communication with the cooktop appliance.

3. The cooktop appliance of claim 2, wherein the operation further comprises:
initiating the first induction element after pairing the first cookware item with the first induction element and pairing the second cookware item with the second induction element;
receiving a remote signal from the second cookware item in response to initiating the first induction element;
unpairing the first cookware item from the first induction element; and
pairing the second cookware item with the first induction element.

4. The cooktop appliance of claim 1, wherein initiating the first induction element comprises:
receiving an input signal via the control panel to energize the first induction element;
activating the first induction element at a first predetermined time interval; and
deactivating the first induction element at a second predetermined time interval.

5. The cooktop appliance of claim 4, wherein receiving the remote signal from the first cookware item in response to initiating the first induction element comprises:
receiving an induction confirmation signal from the first cookware item after the second predetermined time interval.

6. The cooktop appliance of claim 1, wherein the first cookware item comprises:
a temperature sensor; and
a wireless communication module configured to communicate with the cooktop appliance.

7. The cooktop appliance of claim 6, wherein the remote signal comprises a noise output from the temperature sensor in response to the initiation of the first induction element.

8. The cooktop appliance of claim 1, wherein the operation further comprises:
emitting a notification that the first cookware item has been paired with the first induction element.

9. The cooktop appliance of claim 1, wherein the operation further comprises:
initiating a closed loop cooking operation after pairing the first cookware item with the first induction element.

10. A method of operating a cooktop appliance, the cooktop appliance comprising a plurality of induction elements, the method comprising:
initiating a first induction element of the plurality of induction elements;
receiving a remote signal from a first cookware item in response to initiating the first induction element; and
pairing the first cookware item with the first induction element after receiving the remote signal from the first cookware item, wherein the first cookware item is subsequently activated for communication with the cooktop appliance.

11. The method of claim 10, further comprising:
initiating a second induction element of the plurality of induction elements;
receiving a remote signal from a second cookware item in response to initiating the second induction element; and
pairing the second cookware item with the second induction element after receiving the remote signal from the second cookware item, wherein the second cookware item is subsequently activated for communication with the cooktop appliance.

12. The method of claim 11, further comprising:
initiating the first induction element after pairing the first cookware item with the first induction element and pairing the second cookware item with the second induction element;
receiving a remote signal from the second cookware item in response to initiating the first induction element;
unpairing the first cookware item from the first induction element; and
pairing the second cookware item with the first induction element.

13. The method of claim 10, wherein initiating the first induction element comprises:
receiving an input signal via a control panel on the cooktop appliance to energize the first induction element;
activating the first induction element at a first predetermined time interval; and
deactivating the first induction element at a second predetermined time interval.

14. The method of claim 13, wherein receiving the remote signal from the first cookware item in response to initiating the first induction element comprises:
receiving an induction confirmation signal from the first cookware item after the second predetermined time interval.

15. The method of claim 10, wherein the first cookware item comprises:
a temperature sensor; and
a wireless communication module configured to communicate with the cooktop appliance.

16. The method of claim 15, wherein the remote signal comprises a noise output from the temperature sensor in response to the initiation of the first induction element.

17. The method of claim 10, further comprising:
emitting a notification that the first cookware item has been paired with the first induction element.

18. The method of claim 10, further comprising:
initiating a closed loop cooking operation after pairing the first cookware item with the first induction element.
